(19) United States
(12) Patent Application Publication
(10) Pub. No.: US 2009/0175692 A1
(43) Pub. Date: Jul. 9, 2009

(54) PNEUMATIC CONVEYOR SYSTEM

(75) Inventor: Shen-kou Tsai, Sindian City (TW)

Correspondence Address: KIRTON AND MCCONKIE, 60 EAST SOUTH TEMPLE,, SUITE 1800, SALT LAKE CITY, UT, 84111, US

(73) Assignee: BUDDHIST TZU CHI GENERAL HOSPITAL, Sindian City (TW)

(21) Appl. No.: 12/141,726

(22) Filed: Jun. 18, 2008

(30) Foreign Application Priority Data
Jan. 7, 2008 (TW) 097200371

(51) Int. Cl. B65G 53/58

(52) U.S. Cl. 406/96; 406/112

(57) ABSTRACT

A pneumatic conveyor system includes an air blower for supplying an air source, a central control system, a transmission tube, and a transmission terminal installed at the transmission tube. The transmission terminal includes a tubular groove connected with the transmission tube and having a tubular cavity wall surface, above which is a micro-movement sensitive switch and a photoelectric sensor. The system further includes a transmission carrier having a hollow cylindrical axial extension of the body of the carrier and is placed within the cavity of the tubular groove. One of the transmission ends is closed and the other end has an opening, and the opening is built to be closed by a transmission carrier cover. The cover is disposed a ring capable of triggering the micro-movement sensitive switch. When a movement of placing the transmission carrier into the tubular groove triggers the micro-movement sensitive switch and the photoelectric sensor, the air source from the air blower is initiated onto the transmission carrier to push the transmission carrier inside the transmission tube.

### BACKGROUND OF THE INVENTION

1. Field of the Invention

The present invention relates to a pneumatic conveyor system utilizing a transmission tube with compressed air as a mean to carry out the transportation of objects, and more particularly, to a pneumatic conveyor system with a delivery system with a secure loop control device.

2. Description of Prior Art

Generally speaking, the prior art pneumatic conveyor technology utilizes the principle of providing an air blower and air volume manufactured at both ends of the transmission tube so there is a differential air pressure, thus making the air flow in the tube to push or pull the transmission of an object, i.e., a transmission carrier, inside the transmission tube. Needless to say, that the greater the air speed, the higher the pressure inside the transmission tube, and the objects inside the transmission tube are moved more rapidly. Through the layout of the transmission tube being underground or overhead, the pneumatic conveyor makes delivery process subject to no weather restrictions and causes no pollution; in addition, the pneumatic transmission is capable of being set-up inside or outside the business buildings, or even set-up on different buildings to rapidly and effectively transport all kinds of objects. Nowadays, with the pneumatic conveyor being automated and with more flexible transmission routes, it has advantages of saving considerable manpower and time.

The prior art pneumatic conveyor system, when proceeding with transmission and delivery of objects, utilizes a transmission carrier 1, as shown in FIG. 1. The transmission carrier has a hollow axial extended cylindrical body with one end sealed and the other end connected with a carrier cover 10 sealing the cylindrical body of transmission carrier 1. The carrier cover 10 comprises a cover top 103 and a connecting port 101. The connecting port 101 is connected to transmission carrier 1 through an inside screw-like track, or a vertebral connecting device (not shown), to form corresponding structure of the combination with transmission carrier 1. In addition, the carrier cover 10 comprises a push-pull ring 102, whereby the push-pull ring 102 comprises an outer perimeter diameter greater than the outer perimeter diameter of transmission carrier 1. In addition, the push-pull ring 102 outer perimeter diameter is adequately fitting the inner perimeter diameter of the transmission tube of the pneumatic conveyor system, thus, making pushing or pulling the transmission carriers easier inside the transmission tube, and the transmission carriers are more mobile.

In order to accurately deliver the objects inside transmission carrier 1 and transmission carrier 1 through to the system designated transmission terminal, the prior art transmission carrier 1 comprises a micro-chip embedded in the carrier cover 10. Each micro-chip corresponds to a single transmission terminal (ex. hospital laboratories), by reading the embedded micro-chip of carrier cover 10 of every transmission carrier 1, every transmission carrier 1 can be accurately delivered to the system pre-set designated transmission terminal.

However, in the above-mentioned use of transmission carrier for transmission operations, the embedded micro-chip is already set with a fixed signal of the transmission terminal sites; thus, different transmission terminals cannot share the same transmission carrier. Therefore, there is a need for every transmission terminal to have a large number of transmission carriers for different situations, i.e., hospital pharmacy needs transmission carriers for each nursing station, in order to deliver and distribute medications and such to each unit. In the prior art transmission system, although each transmission carrier can be delivered to the system designated location, and the embedded micro-chip on the carrier cover can accurately store terminal site address signal. However, this transmission system requires storage of large number of transmission carriers, thus, creating an economic waste of having to buy these extra transmission carriers and having to store and pile these extra transmission carriers in storage spaces.

In order to improve the above-mentioned transmission system disadvantage, another prior art technology made use of the following method: every transmission terminal is installed and set up a manual command input device (shown in FIG. 2). As long as the site destination code command is inputted to the central control system, the objects and transmission carriers are transmitted to the designated transmission terminals. Thus, every transmission carrier is capable of being used by any transmission terminals and not restricted to a specific transmission terminal. This method greatly improves the ease of using each transmission carrier; however, in this method, the control system no longer needs to rely on the carrier cover embedded micro-chip of transmission carriers to input the transmission terminal site address. In addition, an object placed into a tubular groove 21 as shown in FIG. 2, and the object is detected by photoelectric sensor 210, the pneumatic conveyor system is proceeding with transmission operations. In this case, even if the objects are placed inside the tubular groove 21 and not placed inside the transmission carrier 1, the transmission system still can be activated. So, the slightest negligence or lack of training of the staff worker to mistakenly placing the objects (ex. drugs, medical records, other documents and items) directly inside the tubular groove 21 not using a transmission carrier 1, is still capable of being transmitted as long as the objects are inside the tubular groove 21. Therefore, these objects being mistakenly placed inside tubular groove 21 and transmitted, not only will be unsafely and inaccurately delivered to the pre-set transmission terminals, but also scattered throughout the corners inside the transmission system. As a result, the drugs and documents are lost. In addition, this will also cause the transmission tube being blocked, and more seriously, paralyzing the entire pneumatic conveyor system.

### SUMMARY OF THE INVENTION

An objective of the present invention pneumatic conveyor system is to provide a method to filter whether objects are placed inside the transmission carrier. If the objects are not placed inside the transmission carrier, the system is not activated and no item is transmitted, thus, improve and enhance the efficiency and quality of transmission delivery of objects.

Another objective of the present invention pneumatic conveyor system is to provide a more flexible use of the transmission carriers between different transmission terminals and not restricted to a specific transmission terminal use only. Therefore, this will reduce the need to store and prepare a large number of transmission carriers, and thus, more effectively reduce the system acquisition and operation cost.

Accordingly, the present invention provides a pneumatic conveyor system comprising an air blower for supplying an air source, a central control system, at least a transmission tube, and a transmission terminal installed at the transmission tube. The transmission terminal comprises a frame with a command input device, and a tubular groove selectively open or close and connected with the transmission tube and having a tubular cavity wall surface, above which is a micro-movement sensitive switch and a photoelectric sensor. The pneumatic conveyor system further comprises a transmission carrier having a hollow cylindrical axial extension of the body of the carrier and is placed within the cavity of the tubular groove. One of the transmission ends is closed and the other end has an opening, and the opening of the tube is built to be closed by a transmission carrier cover. The transmission carrier cover is disposed a ring capable of triggering the micro-movement sensitive switch. When a movement of placing the transmission carrier into the tubular groove triggers the micro-movement sensitive switch and the photoelectric sensor, the air source from the air blower enabled by the central control system is initiated onto the transmission carrier to push the transmission carrier inside the transmission tube.

The above-mentioned objectives of the present invention not only can detect whether the transmission carrier is screwed on tightly, this is to avoid the object scattered out when the transmission carrier cover is opened, but also ensuring that the transmission carrier is used as the way to deliver objects via the pneumatic conveyor system, reducing human operational errors, and thus enhancing the efficiency and quality of transmission delivery of objects.

The present invention will be described with reference to the accompanying drawings, which show exemplary embodiments of the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a prior art transmission carrier of a pneumatic conveyor system.

FIG. 2 shows a prior art manual command input device installed at a transmission terminal of a pneumatic conveyor system.

FIG. 3A and FIG. 3B illustrate the transmission terminal according to present invention pneumatic conveyor system.

FIG. 4A and FIG. 4B illustrate enlarged partial diagrams of terminal tubular groove and the transmission carrier according to the present invention pneumatic conveyor system.

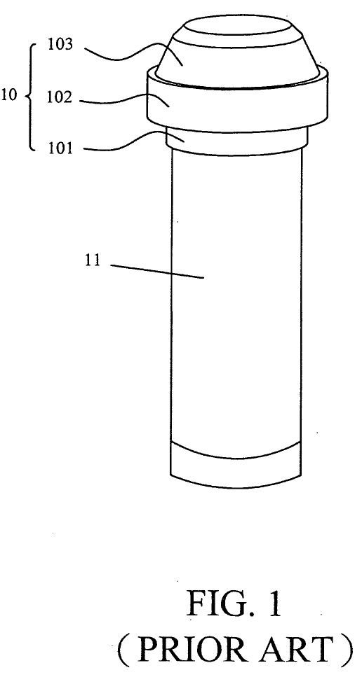

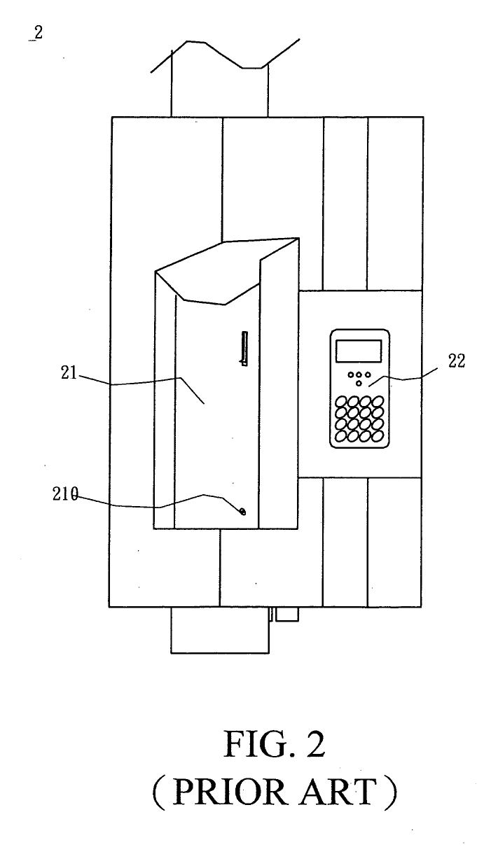

### DETAILED DESCRIPTION OF THE INVENTION

The following figures will illustrate the present invention of pneumatic conveyor system. In particular, the following description of “top” or “bottom” in directional command is referred to the figure scheme shown in relation. These descriptive terms are used tentatively in conjunction with the current figures, and not to limit the scope of the present invention.

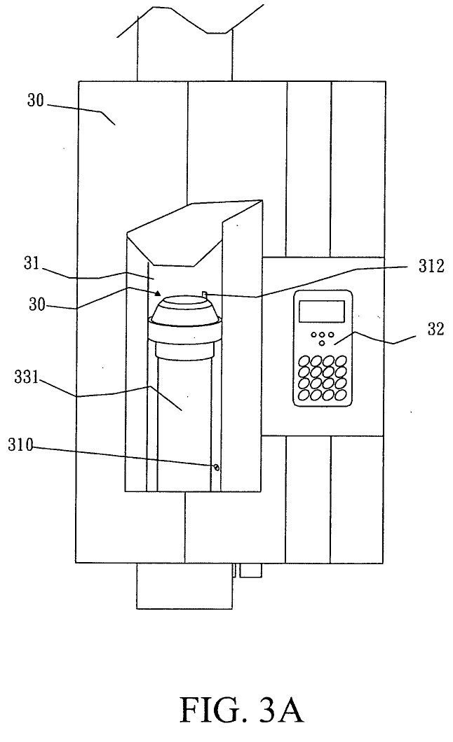

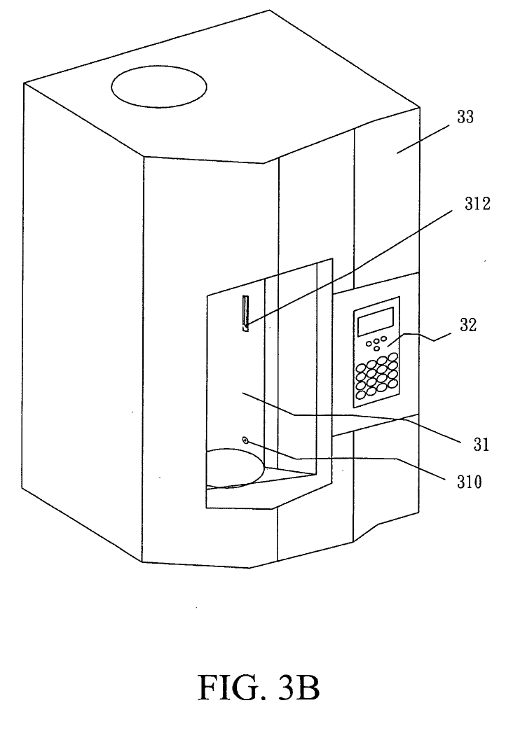

Please refer to FIGS. 3A and 3B, illustrating the pneumatic conveyor system transmission terminal according to the present invention. The pneumatic conveyor system comprises an air blower for using as air source, a central control system, a plurality of transmission terminals for the transmission system, and a plurality of transmission tubes (not shown). According to the present invention pneumatic conveyor system, the transmission terminal 3 is indicated as the transmission start point or destination point, for sending or receiving objects via the pneumatic conveyor system. Every transmission terminal 3 comprises a surface or frame 33 and disposed onto is a command input device 32. The command input device 32 comprises a digital input function or other appropriate input functions for providing input control and operation of relevant command input. The command input device 32 is connected to a central control system, so that the central control system monitors multiple transmission terminals 3 operation status, and shows the inputted command instructions and information, in addition, the terminal site code of the targeted destination transmission terminal.

The transmission terminal 3 comprises a tubular groove 31 having an open area for receiving transmission carrier 3. The transmission terminal 3 is connected to at least one transmission tube, and comprises an adequate closing mechanism, for providing adequate closing or opening of the tubular groove or the receiving chamber, thus, enabling easy access to place or retrieve transmission carrier 30. The closing mechanism is capable of being used in conjunction with any opening or closing receiving chamber mechanism, such that the tubular groove 31 is capable of being constructed as a rotational device that the tubular groove 31 can be rotated adequately to open or close.

The inner tubular wall of tubular groove 31 comprises a micro-movement sensitive switch 312 and a photoelectric sensor 310 which are installed at a distance apart, and are connected to a central control system circuit. According to the present invention, the micro-movement sensitive switch 312 and the photoelectric sensor 310 are installed in a serial distance apart along the tubular axial length of the tubular groove 31. As shown in FIG. 3A and 3B, the micro-movement sensitive switch 312 is installed on the top part of the inner wall of the tubular groove 31, and the photoelectric sensor 310 is installed on the bottom part of the inner wall of the tubular groove 31.

According to the preferred embodiment of the present invention, the micro-movement sensitive switch 312 is a side triggered switch, is capable of being initiated when the transmission carrier 30 is placed inside the tubular groove 31. Moreover, the photoelectric sensor 310 is an electric-eye device, capable of being initiated when the transmission carrier 30 is placed inside the tubular groove 31, hence blocking the light.

In addition, the tubular groove is selectively connected with the transmission tube for receiving the compressed air from the air blower controlled by the central control system. Through properly closing the tubular groove 31, the compressed air is placed on the transmission carrier 30 inside the tubular groove 31. This will be further explained as follows.

The present invention pneumatic conveyor system further comprises a transmission carrier 30, whereby it is capable of being any appropriate size or shape as long as it fits inside the tubular groove 31. In another embodiment of the present invention, the transmission carrier 31 comprises a hollow axial extended cylindrical body 311, that one end is sealed and the other end is an open end (not labeled). In the present embodiment, the cylindrical body 31 outer shape of the transmission carrier 30 corresponding to the tubular groove 31; therefore, the transmission carrier 30 is easily placed inside the tubular groove 31. The cylindrical body 311 of the transmission carrier 30 comprises an open carrier cover 300. The carrier cover 300 comprises a push-pull ring 302. The push-pull ring 302 comprises an outer perimeter diameter bigger than the outer perimeter diameter of transmission carrier 30. More importantly, the push-pull ring 302 outer perimeter diameter is an appropriate size and can be adequately fitted inside the pneumatic conveyor system transmission tube inner perimeter diameter. This is so that air does not leak out when the air blower provides compressed air for pushing or pulling the transmission carrier 30, therefore, providing a more mobile air force for pushing the transmission carrier 30 inside the transmission tube.

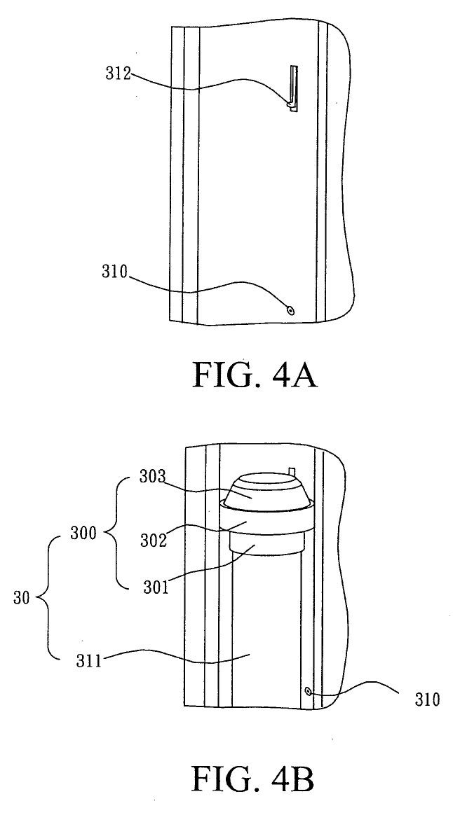

For example, please refer to FIG. 4B, firstly, place the desired items for delivery inside the transmission carrier 30, such as, medical records, medication bags, shock preventing bags, and other items, then, close tightly the carrier cover 300 at the transmission carrier 30 opening so that it is a closed cylindrical body. Next, place the tightly closed transmission carrier 30 into the tubular groove 31 of the transmission terminal 3 and close the tubular groove 31. The photoelectric sensor 310 of the tubular groove 31 will be trigger to detect the presence of transmission carrier 30, in addition, initiating the serially located micro-movement sensitive switch 312 (as shown in FIG. 4A), thus produce a trigger signal. Also, the destination site code of the destination transmission terminal is manually inputted into the command input device 32, the transmission carrier 30 is delivered to the destination via the central controlled system. Moreover, through the design of the photoelectric sensor 310 and micro-movement sensitive switch 312 serially located, if the above-mentioned triggering step is missing the initiation signal from the micro-movement sensitive switch 312, the central control system will not initiate a transmission command, therefore, the pneumatic conveyor system is not transmitting the object. Therefore, the present invention transmission terminal 3 ensures that the pneumatic conveyor system must utilize the transmission carrier 30 in order to trigger micro-movement sensitive switch 312, thereby enabling the central controlled system to accept the command from the transmission terminals to initiate the pneumatic conveyor system to transmit the delivery of transmission carrier 30 to the designated location. The present invention reduces the factor of human operational errors, and increases the process of pneumatic transmission efficiency and quality.

The above-mentioned safety design mechanism of the present invention, the micro-movement sensitive switch 312 and the photoelectric sensor 310 must be separated with an appropriate distance, this is to ensure that only qualified transmission carrier is placed into the transmission terminal 30 of the tubular groove 31 that will trigger micro-movement sensitive switch 312 to generate a trigger signal. In this regard, the micro-movement sensitive switch 312 and photoelectric sensor 310 is separated at best by the distance of the axial length of the transmission carrier 30, for example.

Please refer to FIGS. 4A and 4B, illustrating an enlarged partial diagram of the present invention transmission terminal tubular groove 31 and the transmission carrier 30 placed inside the tubular groove 31, respectively. In the illustrated embodiment, the present invention tubular groove 31 comprises an axially top and bottom part of inner wall surfaces, and installed separately on the top surface, the micro-movement sensitive switch 312, and on the bottom, the photoelectric sensor 310. In addition, the transmission carrier 30 having one open end comprises a carrier cover 300 with a connective part 301. The connective part 301 can be a screw track thread or a vertebral connective device (not shown), for connecting with the transmission carrier 30 opening structure, enabling the transmission carrier 30 to form a closed cylindrical body.

According to the present invention preferred embodiment, when the transmission carrier 30 is placed inside the tubular groove 31, the push-pull ring 302 of the transmission carrier 30 is at a predetermined height that will trigger the location of the micro-movement sensitive switch 312 (shown in FIG. 3). Therefore, if the size or height of transmission carrier 30 is not accordingly, or the user is not using the required transmission carrier 30, the micro-movement sensitive switch 312 is not triggered. In addition, the micro-movement sensitive switch 312 can be triggered by the other parts of the transmission carrier 30. One other advantage of having the push-pull ring 302 to trigger the micro-movement sensitive switch 312 is that when the carrier cover 300 is not properly closed, the push-pull ring 302 will not be able to trigger the micro-movement sensitive switch 312. That is, if the carrier cover 300 and the transmission carrier 30 is not forming a tightly closed structure when placed inside the tubular groove 31, the push-pull ring 302 on the carrier cover 300 is not at the predetermined height that will not trigger the micro-movement sensitive switch 312 to generate a trigger signal. This is a safety detection to avoid the objects inside the transmission carrier 30 from coming lose when the carrier cover 300 is open from not closed tightly with the transmission carrier 30. Moreover, the loosed structure of transmission carrier 30 will slow down the delivery process.

Therefore, the present invention transmission terminal comprises advantages of maintain transmission quality and transmission efficiency; in addition, reducing human operational error thus causing transmission tube congestion or obstruction. As well as, increasing smooth transmission of objects in timely manner and providing transmission facility operation flexibility.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A pneumatic conveyor system, comprising a transmission tube and a transmission terminal installed at the transmission tube, wherein the transmission terminal comprises:
a frame with a command input device;
a tubular groove, selectively open or close and connected with the transmission tube, and the tubular groove having a tubular cavity wall surface, above which is a micro-movement sensitive switch and a photoelectric sensor, wherein the micro-movement sensitive switch and the photoelectric sensor are located along the tubular cavity axial direction and separated by a predetermined distance; and
a transmission carrier having a hollow cylindrical axial extension of the body of the transmission carrier and is placed within the cavity of the tubular groove, wherein one of the transmission ends is closed and the other end has an opening, and the opening of the tube is built to be closed by a transmission carrier cover;
wherein the transmission carrier has an axial size of the tubular groove, when a movement of placing the transmission carrier into the tubular groove triggers the micro-movement sensitive switch and the photoelectric sensor, an external air source in the air pressure is initiated onto the transmission carrier to push the transmission carrier inside the transmission tube.

2. The pneumatic conveyor system of claim 1, wherein the micro-movement sensitive switch is a side touch switch.

3. The pneumatic conveyor system of claim 1, wherein the photoelectric sensor is an electrical-eye device.

4. The pneumatic conveyor system of claim 2, wherein the transmission carrier is set to trigger the micro-movement sensitive switch when placed inside the tubular groove.

5. The pneumatic conveyor system of claim 4, wherein the transmission carrier cover is disposed a ring capable of triggering the micro-movement sensitive switch.

6. The pneumatic conveyor system of claim 1, wherein the micro-movement sensitive switch and the photoelectric sensor are connected in series to a central control system.

7. The pneumatic conveyor system of claim 1, wherein the micro-movement sensitive switch and the photoelectric sensor are separated by a distance of the transmission carrier axial length.

8. An auto-pneumatic conveyor system, comprising:
an air blower for supplying an air source;
a central control system;
at least a transmission tube; and
a transmission terminal installed at the transmission tube, comprising:
a frame with a command input device;
a tubular groove, selectively open or close and connected with the transmission tube, and the tubular groove having a tubular cavity wall surface, above which is a micro-movement sensitive switch and a photoelectric sensor, wherein the micro-movement sensitive switch and the photoelectric sensor are located along the tubular cavity axial direction and separated by a predetermined distance; and
a transmission carrier having a hollow cylindrical axial extension of the body of the carrier and is placed within the cavity of the tubular groove, wherein one of the transmission ends is closed and the other end has an opening, and the opening of the tube is built to be closed by a transmission carrier cover;
wherein the transmission carrier has an axial size of the tubular groove, when a movement of placing the transmission carrier into the tubular groove triggers the micro-movement sensitive switch and the photoelectric sensor, the air source from the air blower enabled by the central control system is initiated onto the transmission carrier to push the transmission carrier inside the transmission tube.

9. The auto-pneumatic conveyor system of claim 8, wherein the micro-movement sensitive switch is a side touch switch.

10. The auto-pneumatic conveyor system of claim 8, wherein the photoelectric sensor is an electrical-eye device.

11. The auto-pneumatic conveyor system of claim 9, wherein the transmission carrier is set to trigger the micro-movement sensitive switch when placed inside the tubular groove.

12. The auto-pneumatic conveyor system of claim 11, wherein the transmission carrier cover is disposed a ring capable of triggering the micro-movement sensitive switch.

13. The auto-pneumatic conveyor system of claim 8, wherein the micro-movement sensitive switch and the photoelectric sensor are connected in series to the central control system.

14. The auto-pneumatic conveyor system of claim 8, wherein the micro-movement sensitive switch and the photoelectric sensor are separated by a distance of the transmission carrier axial length.
